(19) United States
(12) Patent Application Publication
(10) Pub. No.: US 2013/0206512 A1
(43) Pub. Date: Aug. 15, 2013

(54) GREASE FITTING

(71) Applicants: Adrian J. Webb, Raleigh, NC (US); Bart A. Fisher, Roanoke, IL (US)

(72) Inventors: Adrian J. Webb, Raleigh, NC (US); Bart A. Fisher, Roanoke, IL (US)

(73) Assignee: Caterpillar Inc., Peoria, IL (US)

(21) Appl. No.: 13/372,834

(22) Filed: Feb. 14, 2012

(51) Int. Cl. F16N 21/02; F01M 11/04

(52) U.S. Cl. 184/105.3

(57) ABSTRACT

A grease fitting is disclosed. The grease fitting has an outer shell. The outer shell encloses an internal cavity. The outer shell includes a ball check, a hexagonal portion, and a thread blank. The ball check is located at a first end of the outer shell. The ball check is configured to receive grease. The thread blank is located at a second end of the outer shell. The thread blank includes hardened lead threads configured to form threads in an untapped hole. In an embodiment, the grease fitting may include a thread guide extending from the thread blank.

### TECHNICAL FIELD

The present disclosure relates to an improved grease fitting. In a specific embodiment, the present disclosure relates to a linkage pin assembly used in pivoting joints, and more particularly relates to an improved grease fitting and linkage pin of the linkage pin assembly.

### BACKGROUND

A grease fitting is generally a device used at a lubrication point that a grease gun or other lubrication dispensing tool couples to for dispensing grease or other lubricant to the lubrication point. The use of grease fittings to supply grease or other lubricant to mechanical bushings and bearings, without disassembling the bushings and bearings from a joint is generally known. Currently available linkage pin assemblies have a threaded hole provided in a linkage pin to mate with the threads provided on the grease fitting. The pre-existing threads of the linkage pin may get deformed during a heat treating process, leading to a loosening of the mating between the grease fitting and the linkage pin threaded hole. Additionally, the linkage pin assemblies are subjected to machine vibrations. This may lead to the grease fitting becoming loose and falling out of the linkage pin. Thus, there is a need to provide an improved mating between the grease fitting and the linkage pin hole.

U.S. Pat. No. 5,906,047 relates to grease fitting which is made by forming its outer shell in a series of cold forging steps. The grease fitting is drilled to make a hole of three different diameters to form a one-way valve ball seat and two ball spring clearance diameters. The ball and spring are inserted, and the end of the hole is formed over the end of the spring to capture the spring into place.

### SUMMARY OF THE DISCLOSURE

In one aspect, of the present disclosure a grease fitting is provided. The grease fitting has an outer shell. The outer shell encloses an internal cavity. The outer shell further includes a ball check, a hexagonal portion and a thread blank. The ball check is located at a first end of the outer shell and is configured to receive grease. The thread blank is located at a second end of the outer shell and includes hardened lead threads. The hardened lead threads are induction hardened to at least RKW C 53.

In another aspect of the disclosure, a thread guide extending from the outer shell of the grease fitting is provided.

Other features and aspects of this disclosure will be apparent from the following description and the accompanying drawings.

### BRIEF DESCRIPTION OF THE DRAWINGS

FIG. 1 is a side view of an exemplary machine having a grease fitting mated with a linkage pin, according to an embodiment of the present disclosure;

FIG. 2 is an frame structure for another exemplary machine having a lever arm with a grease fitting mated with a linkage pin, according to another embodiment of the disclosure;

FIG. 3 is a side view of an embodiment of a grease fitting;

FIG. 4 is a sectional view of the grease fitting of FIG. 3;

FIG. 5 is a side view of another embodiment of a grease fitting;

FIG. 6 is a sectional view of the grease fitting of FIG. 5;

FIG. 7 is an exploded view of an embodiment of a linkage pin assembly having a grease fitting;

FIG. 8 is a sectional view of the linkage pin assembly of FIG. 7 having the grease fitting of FIGS. 3 and 4;

FIG. 9 is a sectional view of the linkage pin assembly of FIG. 7 having the grease fitting of FIGS. 5 and 6; and

FIG. 10 is a flowchart illustrating a process for fitting a grease fitting in a linkage pin to form an embodiment of a linkage pin assembly.

### DETAILED DESCRIPTION

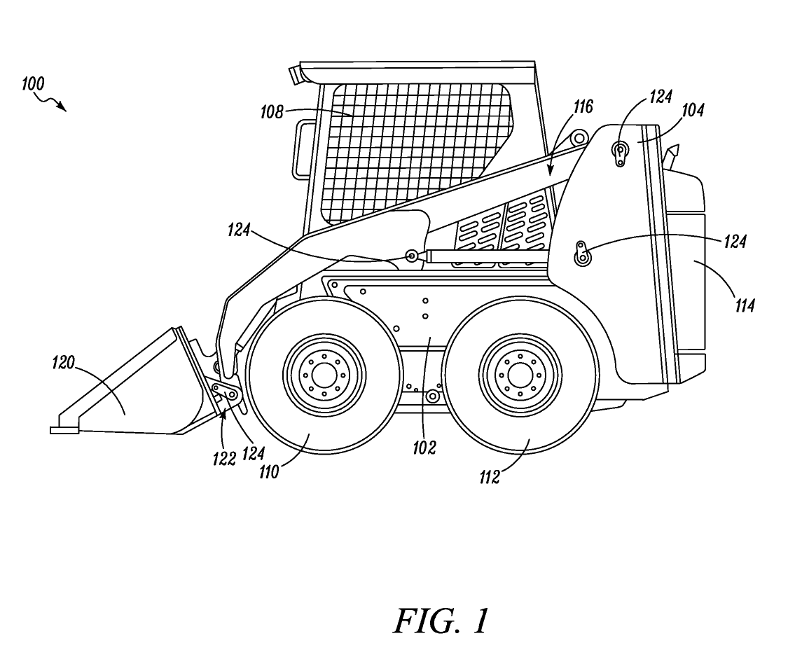

FIG. 1 is a side view of a machine 100, according to one embodiment of the present disclosure. The machine 100 may include or be part of a mobile vehicle. For example, the machine 100 may be, but is not limited to, track type loaders, multi terrain loaders, compact track loaders, mining shovels, wheel loaders, back hoe loaders, motor graders, track type tractors, wheeled tractors, pavers, excavators, material handlers, forestry machines, or any other type of machine, mobile or stationary. For simplicity, the machine 100 is shown and described as a skid steer loader machine.

The machine 100 includes a body 102 having upright stanchions or tower portions 104 on a left and right side of the machine 100, and an operator station 108. Front and rear pairs of drive wheels 110, 112 are mounted to the body 102 and are powered by a power source, such as an engine, (not shown in the figure) which is mounted to the body 102 rearward of the operator station 108 in a rear engine enclosure 114.

The front and rear drive wheels 110, 112 are driven in a manner traditionally known in the art. However, in an alternative embodiment, the front and rear drive wheels 110, 112 may be replaced by left and right endless belts or track assemblies or some other type of drive system (not shown).

Lift arm assemblies 116 are pivotably mounted on the left and right side of the body 102. The machine 100 may also include a work tool 120, such as a bucket, pivotally mounted at a front end of the lift arm assemblies 116. The machine 100 may include a coupler assembly 122 to which the work tool 120 is attached to the lift arm assemblies 116. The coupler assembly 122 may be pivotally connected with the lift arm assemblies 116. To accommodate pivoting, the machine 100 includes a plurality of linkage pin assemblies 124, which are used at pivoting or mechanical joints.

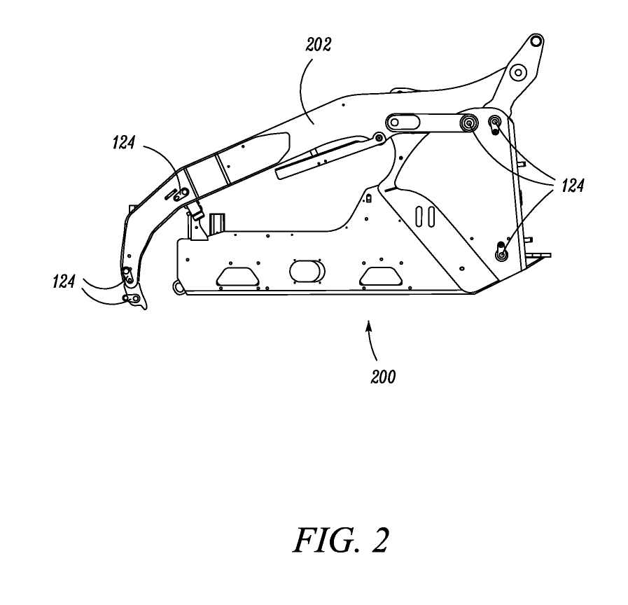

FIG. 2 illustrates an exemplary machine frame 200, according to another embodiment of the present disclosure. The frame 200 includes a lever arm 202. Moreover, the linkage assembly 124 may be present at articulated joints of the frame 200, as shown in FIG. 2. A person of ordinary skill in the art will appreciate that the linkage pin assemblies 124 shown in FIGS. 1 and 2 are merely examples and do not limit the scope of the disclosure. It should also be understood that linkage pin assembly 124 may be present in other applications not described herein.

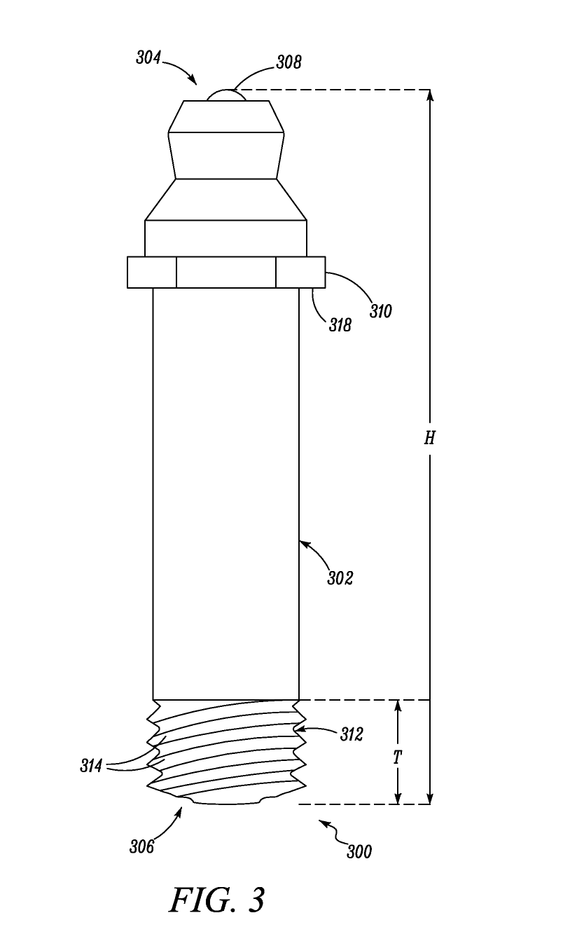

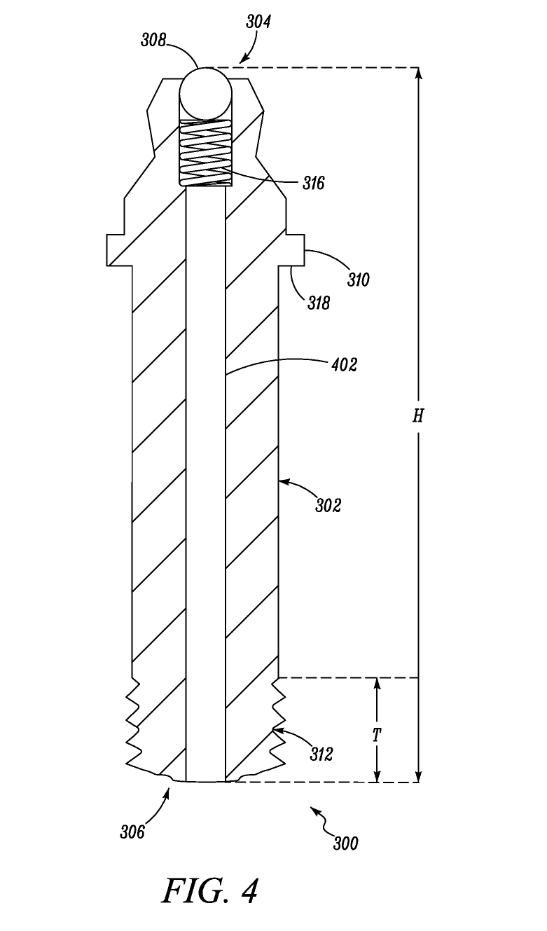

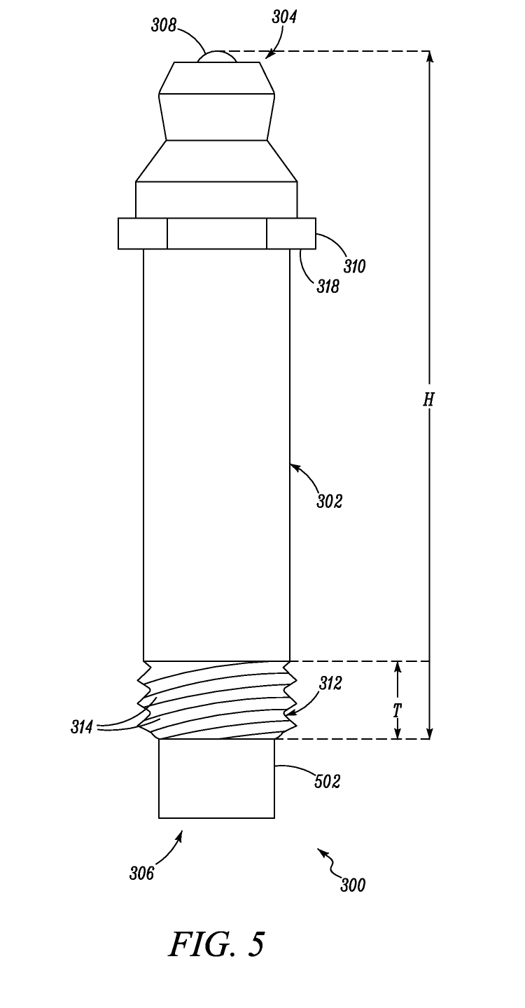

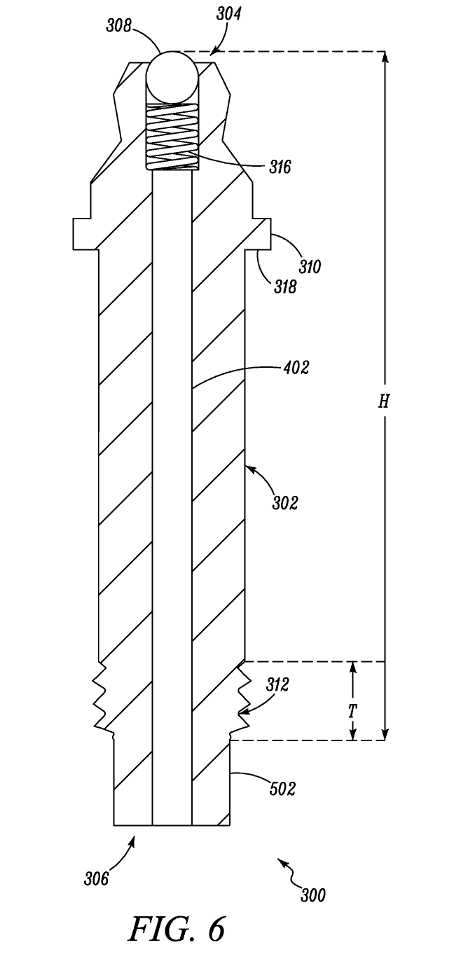

FIGS. 3 and 5 illustrate side views of different embodiments of a grease fitting 300. FIGS. 4 and 6 illustrate sectional views of the grease fitting 300 shown in FIGS. 3 and 5, respectively. The grease fitting 300 includes an outer shell 302. The outer shell 302 may have a fixed length H in a range between approximately 40 mm and approximately 50 mm. In one embodiment, the fixed length H is in a range between approximately 42 mm and approximately 46 mm. In another embodiment, the fixed length H is approximately 44.45 mm. As shown in FIGS. 4 and 6, the outer shell 302 includes an internal cavity 402. The internal cavity 402 runs from a first end 304 to a second end 306 of the grease fitting 300. The internal cavity 402 is provided to carry grease or other lubricant received from a grease gun or other lubricant dispensing device at the first end 304 to a joint or friction point proximate the second end 306. It should be understood that the term grease in the present disclosure may actually refer to any lubricant, grease or otherwise.

Further, the outer shell 302 of the grease fitting 300 may include a ball check 308, a hexagonal portion 310, and a thread blank 312. The ball check 308 is present at and biased toward the first end 304 of the outer shell 302 using spring 316. The ball check 308 receives grease or other lubricant into the internal cavity 402 of the grease fitting 300. Moreover, the ball check 308 may prevent dirt and grit from entering into the grease fitting 300. A person of ordinary skill in the art will appreciate that the outward contour of the first end 304 may provide a known ball and socket joint between the grease fitting 300 and a traditional coupler present in the standard grease gun and/or grease transferring pump assembly. By applying pressure on the biased ball check 308, the grease or other lubricant may flow into the internal cavity 402, but is prevented from flowing in a reverse direction out of the grease fitting 300 when the pressure is removed and the ball check 308 returns to a position seated against an inside end surface of the first end 304.

Further, the hexagonal portion 310 may have a hex size in a range between 7 mm to 15 mm. In one embodiment, the hex size in a in a range between 9 mm and 12 mm. In another embodiment, the hex size is approximately 11.11 mm. As shown in the FIGS. 3 to 6, the thread blank is present at the second end 306 of the outer shell 302. The thread blank 312 is hardened and has a fixed thread length T. In one embodiment, the thread blank 312 may be through hardened in a range between approximately RKW C 33 and approximately RKW C 39.

Moreover, the thread blank 312 includes lead threads 314. The lead threads 314 are hardened. In one embodiment, the lead threads 314 may be induction hardened to at least RKW C 53. A person of ordinary skill in the art will appreciate that the hardening of the thread blank 312 and/or the lead threads 314 may involve a variation of induction, neutral, case hardening, or any combination thereof. The hardening methods and degree described above is merely on an exemplary basis and does limit the scope of the disclosure.

In one embodiment, the grease fitting 300 may have a shank length in a range between approximately 30 mm and approximately 35 mm. In another embodiment, the grease fitting 300 may have the shank length of approximately 32.33 mm. Parameters such as the fixed length H, shank length, wrench size, thread type, and material used in construction may vary without deviating from the scope of the disclosure. As shown in FIGS. 5 and 6, the grease fitting 300 in one embodiment includes a thread guide 502 extending from the thread blank 312 of the outer shell 302. The thread guide 502 may facilitate in providing alignment of the grease fitting 300 within a hole for providing more accurately formed threads in the material receiving the grease fitting 300.

An advantage of the thread guide 502 is that it causes the grease fitting 300 to be mated with an untapped hole in a more co-axial way. In other words, when the thread guide 502 is inserted into a properly sized untapped hole, it generally fits with little excess space between the outer portion of the thread guide 502 and the untapped hole. Accordingly, the length of the thread guide 502 aligns the grease fitting 300 to be substantially concentric with the untapped hole. As such, the grease fitting 300 is more likely to screw into the untapped hole substantially centered in the untapped hole. This makes a better fit between the grease fitting 300 and the untapped hole. In addition, when the grease fitting 300 is properly located in the untapped hole, a lower surface 318 of the hexagonal portion 310 of the grease fitting 300 will be substantially parallel to and flat with an upper surface of the untapped hole. As should be understood, when the lower surface 318 of the hexagonal portion 310 and the upper surface of the untapped hole have continuous contact around the perimeter of the untapped hole this creates an additional seal with additional friction to keep the grease fitting 300 tight in the untapped hole.

In another embodiment, the lower surface 318 of the hexagonal portion 310 may include a texture, a coating, an adhesive, or other configuration to increase friction between the lower surface 318 of the hexagonal portion 310 and the upper surface of the untapped hole. In yet another embodiment, the thread guide 502 is hardened similar to the thread blank 312 and/or the lead threads 314. In an embodiment, the outer diameter of the thread guide 502 is substantially similar to a smallest diameter of the thread blank 312. In still another embodiment, the outer diameter of the thread guide 502 may be 1-2 mm smaller than the smallest diameter of the thread blank 312.

The grease fitting 300 may be made of carbon steel, mild steel, stainless steel, brass, or any other suitable material. Also, in one embodiment, the outer shell 302 of the grease fitting 300 may be yellow zinc plated in order to reduce corrosion. A person of ordinary skill in the art will appreciate that the grease fitting 300 described above is merely on an exemplary basis. The dimensions may vary without deviating from the scope of the disclosure. Moreover, the grease fitting 300 may additionally include other structures not described herein.

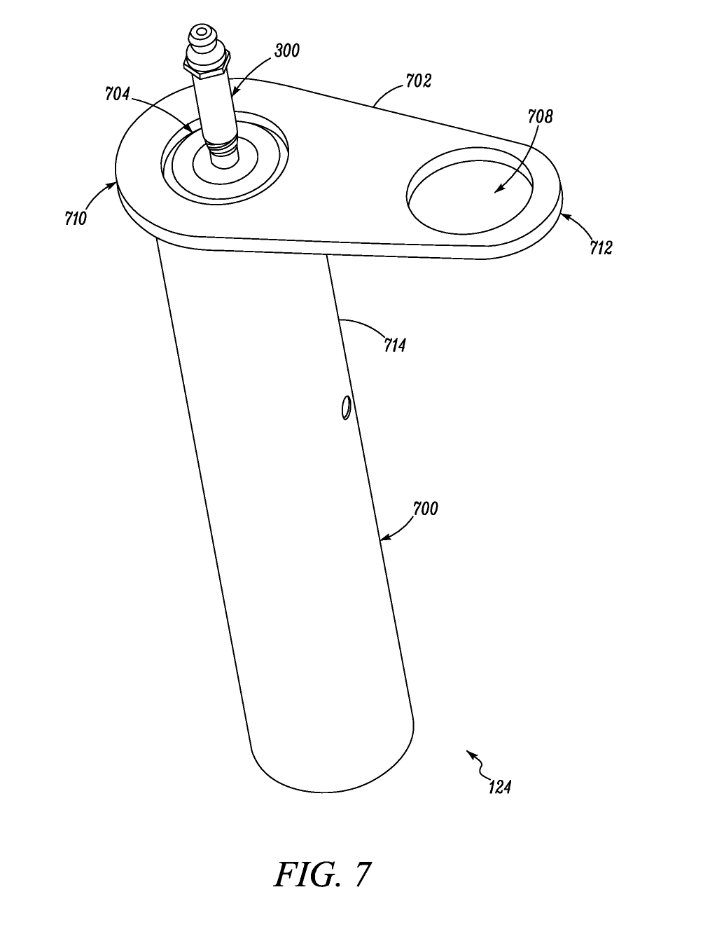

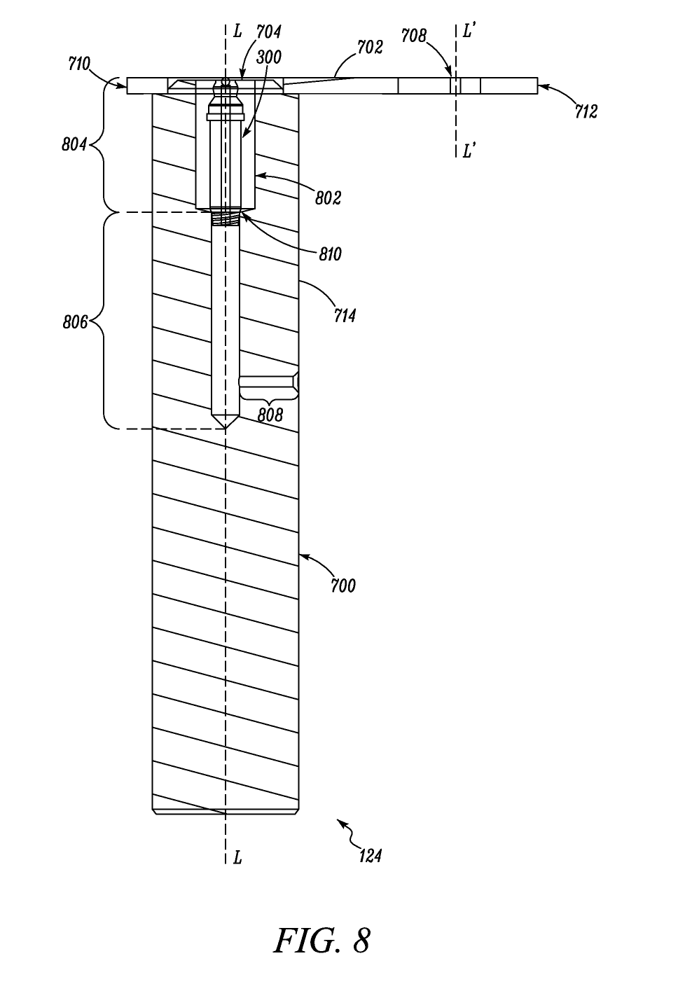

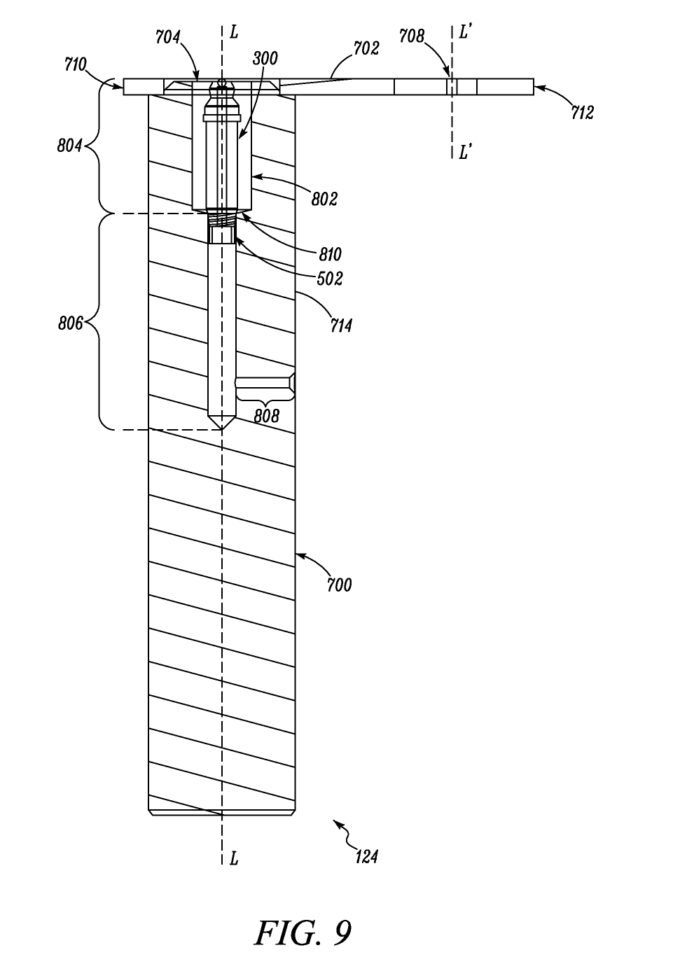

The linkage pin assembly 124, as shown in FIGS. 7 to 9 includes the grease fitting 300 inserted into a linkage pin 700. The linkage pin 700 has an untapped hole 802. The grease fitting 300 may be inserted into the untapped hole 802 of the linkage pin 700. FIGS. 8 and 9 are the sectional views of the linkage pin assembly 124 including the grease fitting 300 inserted into the linkage pin 700.

The linkage pin 700 may have a lever arm 702. The lever arm 702 may have a first and second aperture 704, 708 located at a first and second end 710, 712. The first and second apertures 704, 708 may define a first and second longitudinal axis LL and L′L′. The first and second longitudinal axes LL and L′L′ are substantially parallel to each other. The linkage pin 700 may further include a case 714. The case 714 is attached to the first aperture 704 and has the untapped hole 802.

As shown in FIGS. 8 and 9, in one embodiment, the untapped hole 802 has a first section 804, a second section 806, and a third section 808. The first section 804 is along the first longitudinal axis LL and is configured to receive the grease fitting 300. The linkage pin assembly 124 includes a coupling 810 between the grease fitting 300 and the linkage pin 700, such that the hardened lead threads 314 create corresponding threads in the untapped hole 802 of the linkage pin 700 when the grease fitting 300 is inserted into the linkage pin 700. The grease fitting 300 may be inserted into the linkage pin 700 using a torque wrench or gun and torqued to a desired torque setting. In one embodiment, the linkage pin 700 is toleranced corresponding to the grease fitting 300.

The second section 806 extends from the first section 804, in the direction of the first longitudinal axis LL. The second section 806 is configured to pass the grease received via the grease fitting 300 to the third section 808. The third section 808 extends from the second section 806, towards an outer surface of the case 714. The third section 808 passes the grease to the joint at which the linkage pin assembly 124 is used.

### INDUSTRIAL APPLICABILITY

The above disclosed linkage pin 700 provides an improved mating between the grease fitting 300 and the linkage pin 700.

As described above, the linkage pin 700 includes an untapped hole 802. Moreover, the grease fitting 300 includes hardened lead threads 314. The hardened lead threads 314 have a thread forming functionality such that the corresponding threads are created in the untapped hole 802 of the linkage pin 700 when the grease fitting 300 is coupled with the linkage pin 700 by rotating the grease fitting 300 (e.g., clockwise or counter-clockwise) into the untapped hole 802 to “screw” the grease fitting 300 into the untapped hole 802. The use of the untapped hole 802 may alleviate the need for additional thread cutting processes.

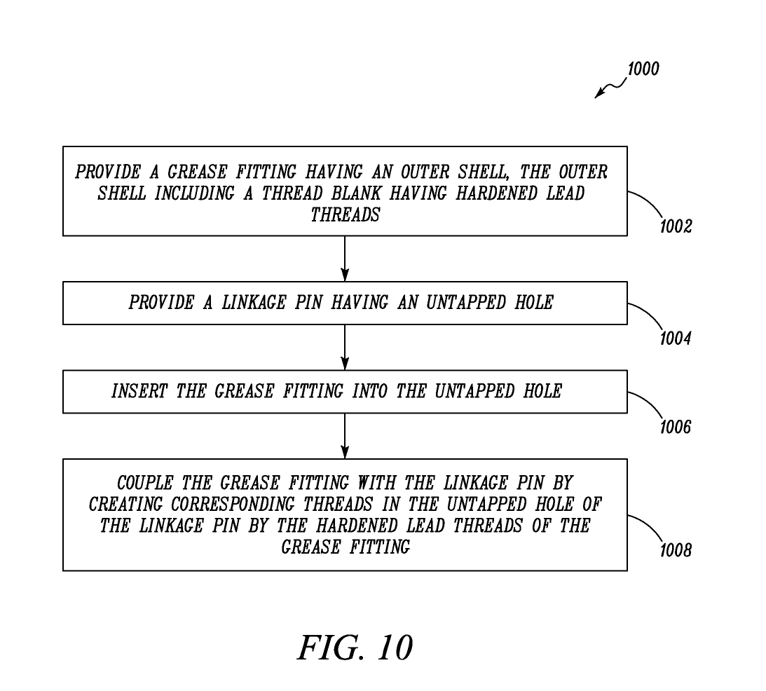

FIG. 10 illustrates a flowchart for a process 1000 of fitting a grease fitting into an untapped hole of a linkage pin. Initially, at step 1002, the grease fitting 300 is provided. In an embodiment, the grease fitting 300 has the fixed length H in the range between approximately 40 mm and approximately 50 mm. However, other lengths H may be used for the grease fitting 300. The grease fitting 300 has the outer shell 302 and the internal cavity 402. Moreover, the outer shell 302 includes a thread blank 312. In one embodiment, the thread blank 312 may be hardened. The thread blank 312 may be through hardened in the range between approximately RKW C 33 and approximately RKW C 39. Moreover, the thread blank 312 may include hardened lead threads 314. The lead threads 314 may be induction hardened to at least RKW C 53. A person of ordinary skill in the art will appreciate that the values stated above are on an exemplary basis and may vary. In another embodiment, the grease fitting 300 includes the thread guide 502. The thread guide 502 provides improved alignment for guiding the grease fitting 300 into the untapped hole 802 of the linkage pin 700, and thus, provides a straighter alignment of the grease fitting 300 in the untapped hole 802.

A person of ordinary skill in the art will appreciate that the hardened lead threads 314 may be provided on the grease fitting 300, in order to accomplish a thread forming function.

At step 1004, the linkage pin 700 having the untapped hole 802 is provided. In one embodiment, the linkage pin 700 is toleranced in accordance with the grease fitting 300. A person of ordinary skill in the art will appreciate that controlling the tolerance of the untapped hole 802 which has a straight or rectilinear shape is easier than controlling the tolerance of the known pre-machined threaded hole.

Subsequently, at step 1006, the grease fitting 300 is inserted into the untapped hole 802 of the linkage pin 700. The grease fitting 300 may be inserted into the linkage pin 700 using a torque wrench or gun and torqued to any desired torque setting. At step 1008, the grease fitting 300 is coupled with the linkage pin 700. The coupling 810 is formed by creating corresponding threads in the untapped hole 802 of the linkage pin 700 by the hardened lead threads 314 of the grease fitting 300, on the insertion of the grease fitting 300 into the linkage pin 700.

A person of ordinary skill in the art will appreciate that the grease fitting 300 and the linkage pin assembly 300 described above may include other structures not described herein. Although the linkage pin assembly 124 has been described in connection with machine 100 and the framework 200, the disclosure may also be used in connection with any mechanical joint where lubrication is provided using the linkage pin assembly 124.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A grease fitting comprising:
an outer shell enclosing an internal cavity, the outer shell including:
a ball check at a first end of the outer shell, the ball check configured to receive grease;
a hexagonal portion; and
a thread blank at a second end of the outer shell, the thread blank including hardened lead threads, wherein the hardened lead threads are induction hardened to at least RKW C 53.

2. The grease fitting of claim 1, wherein the thread blank is through hardened in a range between RKW C 33 and RKW C 39.

3. The grease fitting of claim 1, wherein the outer shell has a fixed length in a range between 40 mm and 50 mm.

4. The grease fitting of claim 1, wherein the outer shell has a fixed length in a range between 42 mm and 46 mm.

5. The grease fitting of claim 1, wherein a shank length of the grease fitting is in a range between 30 mm and 35 mm.

6. The grease fitting of claim 1, wherein the hexagonal portion has a hex size in a range between 7 mm and 15 mm.

7. The grease fitting of claim 1, wherein the hexagonal portion has a hex size in a range between 9 mm and 12 mm.

8. The grease fitting of claim 1, wherein the outer shell is uniformly case hardened.

9. A grease fitting comprising:
an outer shell enclosing an internal cavity, the outer shell including:
a ball check at a first end of the outer shell, the ball check configured to receive grease;
a hexagonal portion; and
a thread blank at a second end of the outer shell, the thread blank including hardened lead threads, wherein the hardened lead threads are induction hardened to at least RKW C 53; and
a thread guide extending from the thread blank of the outer shell, the thread guide configured to align the grease fitting to be substantially concentric with an untapped hole of a linkage pin.

10. The grease fitting of claim 9, wherein the thread blank is through hardened in a range between RKW C 33 and RKW C 39.

11. The grease fitting of claim 9, wherein the outer shell has a fixed length in a range between 40 mm and 50 mm.

12. The grease fitting of claim 9, wherein the outer shell has a fixed length in a range between 42 mm and 46 mm.

13. The grease fitting of claim 9, wherein a shank length of the grease fitting is in a range between 30 mm and 35 mm.

14. The grease fitting of claim 9, wherein the hexagonal portion has a hex size in a range between 9 mm and 12 mm.

15. The grease fitting of claim 9, wherein the hexagonal portion has a hex size in a range between 7 mm and 15 mm.

16. The grease fitting of claim 9, wherein the outer shell is uniformly case hardened.

17. The grease fitting of claim 9, wherein an outer diameter of the thread guide is between 1 mm to 2 mm smaller than a smallest diameter of the thread blank.

18. The grease fitting of claim 9 further including a coating provided on a lower surface of the hexagonal portion configured to increase friction between the lower surface of the hexagonal portion and an upper surface of the untapped hole.
